(19) United States
(12) Patent Application Publication
(10) Pub. No.: US 2025/0299203 A1
(43) Pub. Date: Sep. 25, 2025

(54) HEAT PUMPS AND OTHER MACHINES HAVING A MINING COMPONENT

(71) Applicant: DALRADA FINANCIAL CORPORATION, ESCONDIDO, CA (US)

(72) Inventor: Nicola DiCicco, ESCONDIDO, CA (US)

(73) Assignee: DALRADA FINANCIAL CORPORATION, ESCONDIDO, CA (US)

(21) Appl. No.: 19/079,935

(22) Filed: Mar. 14, 2025

Related U.S. Application Data
(60) Provisional application No. 63/567,852, filed on Mar. 20, 2024.

(51) Int. Cl. G06Q 30/018; F24F 11/46; G06Q 40/04

(52) U.S. Cl. CPC G06Q 30/018; F24F 11/46; G06Q 40/04; G06Q 2220/00

(57) ABSTRACT

In one embodiment, a system includes a machine that includes one or more electrical components. The system also includes a mining component electrically coupled to the machine, the mining component includes one or more processors. The system also includes a mining component electrically coupled to the machine, the mining component includes a non-transitory computer-readable medium storing instructions that, when executed by the one or more processors, causes the one or more processors to generate operational data of the machine, receive power source data, determine a carbon utility equivalent from the operational data and the power source data, generate a carbon utility token from the carbon utility equivalent, and record the carbon utility token on a blockchain.

### CROSS-REFERENCE TO RELATED APPLICATIONS

This application claims priority to U.S. Provisional Application No. 63/567,852 entitled “Systems and Methods for Carbon Utility Token Mining” filed on Mar. 20, 2024, the contents of which are incorporated by reference in its entirety.

### BACKGROUND

There is a desire to reduce the amount of carbon released into the atmosphere to minimize the effect of carbon on the planet's temperature and weather. One approach to incentivize carbon reduction is to issue carbon credits, which are created based on the carbon offsets. One carbon credit allows the owner to emit a one ton of carbon dioxide into the environment. However, carbon credits are not issued based on actual measured performance by a device, machine or system. Further, carbon credits are not easily tracked, and require third party verification. The carbon credit system invites the risk of fraud.

Another approach to incentivize carbon reduction is to purchase and install more efficient electrical equipment utilizing modern technology. However, such modern equipment may be prohibitively expensive. Further, the amount of money saved by operating new efficient equipment may never equal or exceed the increased purchasing cost of the equipment. This may discourage users from purchasing more efficient equipment, and instead operating old equipment that produces greater amounts of carbon dioxide.

Accordingly, alternative devices and methods for incentivizing the purchase and use of energy efficient equipment may be desired.

### SUMMARY

The purpose of embodiments of the present disclosure is to create an internal carbon credit token minting process integrated with a particular machine, such as a heat pump, allowing carbon utility tokens to be created, recognized by governing bodies, and traded on open market. This technology can also be used with any device that uses electricity (e.g., air conditioners, home energy management systems, and the like). In other devices, different criteria may be available to mint carbon utility tokens.

Embodiments of the present disclosure are directed to systems and methods for generating and minting carbon utility tokens based on both how efficiently carbon is consumed by equipment and also how efficient and “clean” the sources of the electrical power consumed by the machine is. Information regarding how “clean” the sources of electrical power may be provided by third-party providers or by the power suppliers themselves. Thus, the carbon utility tokens described herein take into account the efficiency of a particular machine rather than just the amount of electrical power consumed and the source of the electrical power.

In one embodiment, a system includes a machine that includes one or more electrical components. The system also includes a mining component electrically coupled to the machine, wherein the mining component includes one or more processors. The system also includes a mining component electrically coupled to the machine, wherein the mining component includes a non-transitory computer-readable medium storing instructions that, when executed by the one or more processors, causes the one or more processors to generate operational data of the machine, receive power source data, determine a carbon utility equivalent from the operational data and the power source data, generate a carbon utility token from the carbon utility equivalent, and record the carbon utility token on a blockchain.

In another embodiment, a method for operating a machine includes receiving operational data of the machine, receiving power source data, determining a carbon utility equivalent from the operational data and the power source data, generating a carbon utility token from the carbon utility metric, recording the carbon utility token on a blockchain, receiving one or more operational parameters based on one or more of the carbon utility equivalent and the carbon utility token, and controlling an operation of the machine based on the one or more operational parameters.

In another embodiment, a heat pump includes an evaporator coil, a condenser coil, a compressor fluidly coupled to the evaporator coil and the condenser coil, an expansion valve fluidly coupled to the evaporator coil and the condenser coil, and one or more fans operable to generate airflow over one or more of the evaporator coil and the condenser coil. The heat pump also includes a mining component including one or more processors and a non-transitory computer-readable medium storing instructions that, when executed by the one or more processors, causes the one or more processors to generate operational data of the heat pump, receive power source data, determine a carbon utility equivalent from the operational data and the power source data, generate a carbon utility token from the carbon utility equivalent, and record the carbon utility token on a blockchain.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure, and are incorporated into and constitute a part of this specification. The drawings illustrate various embodiments and together with the description serve to explain the principles and operation.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example heat pump and carbon utility token mining system according to one or more embodiments described and illustrated herein.

FIG. 2 illustrates an example method for mining carbon utility tokens according to one or more embodiments described and illustrated herein.

FIG. 3 illustrates an example heat pump according to one or more embodiments described and illustrated herein.

FIG. 4 illustrates an example mining component according to one or more embodiments described and illustrated herein.

### DETAILED DESCRIPTION

Embodiments of the present disclosure are directed to systems and methods for generating and minting carbon utility tokens based on both how efficiently carbon is consumed by equipment and also how “clean” the sources of the electrical power consumed by the machine is. Thus, the carbon utility tokens described herein take into account the efficiency of a particular machine using a mining device rather than just the amount of electrical power consumed and the source of the electrical power.

Generally, embodiments of the present disclosure quantify the source of the electrical power (i.e., the electrical power generated by various sources, such as coal power plants, natural gas power plants, nuclear power plants, solar farms, hydroelectric generators, biofuel plants, and the like), as well as how efficiently a particular machine operates as compared to a theoretical maximum. It is noted that quantifying how efficiently a particular machine operates and providing a reward in the form of carbon utility tokens incentivizes parties to invest in more efficient machines, even if such machines are more expensive to purchase. Embodiments are distinguished from merely evaluating a carbon reduction by taking into account how efficient the machine operates. For example Machine A may be much less efficient than Machine B. Both machines may be operated such that they consume the same amount of carbon, but Machine B may operate much longer than Machine A because of its increased efficiency. Merely monitoring carbon reduction may not capture the increased efficiency of Machine A.

As described in more detail below, the carbon utility tokens described herein capture and quantify the efficiency of the respective machine by comparing the machine's performance against a theoretical maximum efficiency. Thus, embodiments apply electricity usage by potentially any machine and calculate the machine's efficiency compared to the theoretical maximum. This allows for comparison against less efficient machines or more efficient machines. Ultimately any machine can be used and generate carbon utility tokens; however the better the machinery, the more carbon utility tokens will be generated. This drives innovation, efficiency, and clean energy to be at the forefront of the drive.

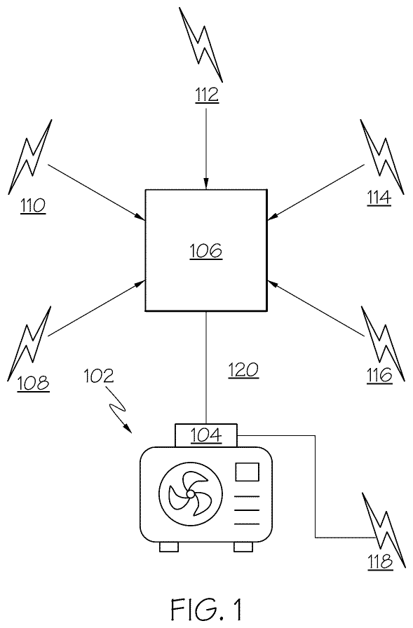

Referring now to FIG. 1, an example machine in the form of a heat pump 102 is schematically illustrated. It should be understood that any type of machine may be utilized, and the heat pump 102 is used for illustrative purposes only. A heat pump 102 utilizes electrical power to both remove heat from a space, such as dwelling, to cool the space, as well as move heat from an exterior to an interior of the space to heat the space. Thus, heat pumps 102 operate in both a heating cycle and a cooling cycle. In the cooling mode, a refrigerant receives heat from the space, is compressed and heated by a compressor, and then cooled by use of a fan to remove the heat to the exterior. The pressure of the refrigerant is reduced by an expander and then reintroduced into the space to once again receive interior heat. In the heating mode, cold refrigerant receives heat from the exterior, is compressed and heated by the compressor, and is then cooled by use of a fan to remove the heat of the refrigerant to the space. The pressure of the refrigerant is reduced by the expander and then reintroduced to the exterior to once again receive exterior heat. Heat pumps 102 are known to operate at greater efficiencies than electrical heating systems or gas furnaces.

The heat pump 102 receives electrical power from a power provider 106 by way of one or more transmission lines 120. Heat pumps 102 generally operate on single phase electrical power; however, it should be understood that embodiments of the present disclosure can operate on three phase machines as well.

The power provider 106 may provide the heat pump with a blend of electrical power generated from a plurality of power generators 108-116 (also referred to herein as power sources). Each power generator 108-116 may generate electrical power in a different manner, with some being more carbon intensive than others. Renewable energy sources are generally less carbon intensive (i.e., generate less carbon when producing electrical energy) than energy sources relying on the burning of fossil fuels. As non-limiting examples, power generator 108 may be a solar field, power generator 110 may be a hydroelectric plant, power generator 112 may be nuclear power plant, power generator 114 may be a natural gas power plant, and power generator 116 may be a coal power plant. Each of the power generators 108-116 provide some proportion of the overall electrical power provided by the power provider 106, which is referred to as the power blend. The power blend determines the carbon intensity of the electrical power that is provided. Carbon intensity is a metric used to quantify how clean the electrical power is. It refers to how many grams of carbon dioxide are released to produce one kilowatt hour of electricity. Thus, the lower the carbon intensity, the “cleaner” the electrical power.

In some cases, the machine, such as the heat pump 102 of FIG. 1, may operate on one or more local power generators 118, such as on-property solar panels or wind turbines, for example.

The embodiments of the present disclosure further include a mining component 104, which is physical equipment attached to or otherwise associated with the machine (e.g., heat pump 102) that monitors the electrical power consumed and the receives external data input, such as carbon intensity or power blend information from the power generator 116 to generate and mint carbon utility tokens that may be recorded on a blockchain and traded in a carbon marketplace. Thus, the mining component 104 both monitors the electrical power usage and also generates carbon utility tokens.

Embodiments are not limited to the hardware components of the mining component 104. As a non-limiting example, the mining component may include one or more clamp meters and/or other sensors for monitoring electrical power usage, a programmable logic controller (PLC), or any similar logic devices that may or may not have input/output and logical operation capacity, operable to receive sensor data, such as data from a clamp meter. The PLC may also be operable to receive external inputs (e.g., over an Internet connection, such as a wired connection or a wireless connection (e.g., an Internet of Things device)), such as electrical power blend and/or carbon intensity from the power provider 106. The PLC can thus gather operational data regarding the machine, such as the coefficient of performance (cOP) heating, cOP cooling, input kW, fluid temperature, etc. The operational data can be read directly from the machine, and/or retrieved from external sources by a wired or wireless connection.

The operational data can be provided to a secondary computing or storage device, such as a system-on-a-chip, that allows for the integration of the operational data to be stored for a direct connection using an Ethernet cable (or other connection means to connect to the PLC (e.g., an intranet) and another Ethernet cable to connect to the Internet via another connection (e.g., server room, switch, etc.).

The mining component 104 creates a secure layer of trust to prevent access to the intranet of a company using the invention and provides a root-of-trust whereby the tokens can be minted onto a blockchain. This may include hardware security modules, firmware, and/or software that follow industry standards of cryptography and security protocols. Special-designed protocols may be implemented to provide analog implementations should the risk of electronic communication be warranted. Flash memory devices may be of use with separation barriers to provide proper segregation between machine, data storage, and software integrations. Read and write privileges are of one concern that may or may not be separated to create an additional barrier to entry.

Once the operational data is gathered, a carbon utility equivalent for the operation of the machine is determined either by the mining component 104 itself or by a remote computer, such as a remote server. The carbon utility equivalent is the basis for the carbon utility token that is minted, and is reflective of both the carbon intensity of the power provider 106 and the efficiency of the particular machine, such as the heat pump 102.

The carbon utility equivalent is determined by comparing a consumption metric (CM) of performance against a theoretical maximum performance for a particular machine. The consumption metric may be any metric quantifying the efficiency of the machine. In the heat pump 102 example, the cOP for heating and the cOP for cooling are consumption metrics that compared against the theoretical maximum efficiency/performance. As a non-limiting example, if a theoretical maximum performance is 1.0, and the heat pump 102 operates as 0.8, the heat pump 102 would be given a consumption metric of 0.8. It should be understood that other machines may use different consumption metrics.

The carbon utility equivalent also considers the power blend (PB) or, in other words, the carbon intensity, of the electrical power that is consumed by the machine. For example, the power provider 106 may provide electrical power at a particular carbon intensity, which when normalized is equal to a PB of 0.7, where a value of 1.0 is reflective of carbon-neutral electrical power generation.

The carbon utility equivalent is determined by multiplying the consumption metric and the power blend together. Therefore, in the above example, the carbon utility equivalent would be equal to 0.56 (0.8 CM×0.7 PB=0.56). If a machine is operating at 100% of its theoretical maximum performance, and is operating on carbon neutral electricity, the carbon utility value will be equal to 1.0.

In some embodiments, the efficiency (PE) of the of the power sources is also taken into account as well as, or in lieu of, the carbon intensity, or power blend of the power provider. The efficiency PE of the power source is the efficiency of the various power sources. For example, a coal plant may operate at 33% efficiency, whereas a solar plant may operate at 80% efficiency, for example. The efficiency may be the average efficiency of all of the power generators 108-116 utilized by the power provider 106. Thus, the carbon utility equivalent may be calculated by multiplying the power blend, power source efficiency and the consumption metric together. As a non-limiting example, the carbon utility equivalent may be 0.7 PB×0.46 PE×0.8 CM=0.2576. It should be understood that any one or more of the power blend, power source efficiency and the consumption metric may be utilized in any combination to calculate the carbon utility equivalent. For example, in some cases the power blend and/or the power source efficiency may not be available from the power provider 106.

The carbon utility equivalent of the machine may be monitored over periods of time in which the machine is operated, and used to mint carbon utility tokens for those periods of time. For example, the carbon utility equivalent may be calculated by the number of kilowatt-hours used by the particular machine to mint the carbon utility token. For example, a monitored machine many have operated at 54 kWh with a carbon utility equivalent of 0.2575 over a period of time that results in 13.91 carbon utility tokens minted.

Because the efficiency of the power sources utilized by the power provider changes over time, the carbon utility equivalent will also change over time. For example, during a sunny day the delivered electrical power may be generated primarily from solar arrays, which have a high efficiency. The carbon utility equivalent of a machine operating during this sunny day may be relatively high. However, when the sun goes down and demand increases, power providers may rely on more carbon intensive power plants, such as coal and natural gas power plants. Thus, the carbon utility equivalent of a machine during the evening hours may be lower than the carbon utility equivalent of the same machine during a sunny day.

In some embodiments, a user may input one or more operational parameters into the mining component 104 or another computing device that transmits the one or more operational parameters to the mining component 104. The one or more operational parameters may include, for example, a threshold carbon utility token rate or a threshold carbon utility equivalent level. The operation of the machine may be controlled by the mining component 104 based on the one or more operational parameters that are provided to it. The mining component 104 may be communicatively coupled to the machine such that the mining component 104 can control functionalities of the machine. For example, the mining component 104 may be capable of turning the machine on and off, or causing the machine to operate and different power levels or in different operating modes. As a non-limiting example, a user may desire to operate the machine only when it is capable of producing carbon utility tokens at a desirable rate. A threshold carbon utility token rate may be set by the user. When the machine mints carbon utility tokens below the threshold carbon utility token rate, the user may program the mining component 104 to turn off the machine until the efficiency of the power sources improves. As another non-limiting example, a user may have a plurality of machines, with some operating at a better efficiency than others. When the threshold carbon utility token rate is not satisfied, the less efficient machines may be turned off and the more efficient machines may be turned on. When the threshold carbon utility token rate is satisfied, the less efficient machines may be turned on and the more efficient machines may be turned off or be allowed to continue to be run.

The minting of the carbon utility tokens can take place via a blockchain or blockchain-like method, for instance Hedera (on a hash graph) and incorporate smart contract implementation to control the flow of the tokens and their usage. This data can be verified and viewed in the future should there ever be a concern over integrity of the system and for an exercise in confirmation or study of the standard being utilized.

The blockchain and wallet integration may be coded and the assumption's built-in would include but not be limited to: identifying the machine, using the technology to calculate carbon utilization equivalent token, verifying the integrity and validity of the information, and the supply that exists.

Assuming that a smart contract implementation is utilized, there are many considerations to be had. For instance, since energy offset could be transient in nature, it is ideal to have a time-limit or expiration on a carbon utility token. The token, however, may have an expiration as determined in the future. This solves multiple issues including but not limited to: an infinite supply of carbon utility tokens being accrued and a market liquidity concern (if tokens expire, they must be traded before the end-date otherwise the value diminishes to zero, and therefore they would be traded before expiration if understood to a logical participant). In other embodiments, the carbon utility tokens will never expire.

As a non-limiting example, the blockchain may incorporate the usage of a multi-chain protocol: one chain for generation of a carbon token, one chain for transaction of a carbon token, and a final chain for expiration/retirement of a token. These the chains may be the independent chains, the separate algorithms/functions on a single chain or some combination thereof. The generation chain may pass the generation of the token to the retirement/expiration chain to start the so-called “clock” for when the value of the carbon token will terminate and become 0. This will allow for proper utilization of the tokens for transactional and counter-party risks of these transactions. The transaction chain may have all of the transactional information and is connected via the generation and retirement/expiration chain. These may be thought of as independent or unique occurrences connected throughout with the blockchain. This may be pre-defined upfront and may not change after generation. A simple example is a 36-month period. This may or may not be used due to requirements and infrastructure within a system, but this method provides for the resilience of the token supply and demand economics by controlling supply by design.

In some embodiments, the consumption data gathered by the mining component 104 and the resulting minted carbon utility tokens are verified by different nodes (e.g., other mining components 104 associated with other machines, such as other heat pumps) to prevent fraud. For example, a second mining component may receive raw data such as power consumed, time of consumption, and energy blend and a carbon utility token calculated from a first mining component. The second mining component (or other computing device) may perform its own calculation of the carbon utility token using the raw data to verify that the carbon utility token (or some other value) is accurate. In some embodiments, the calculations are validated by determining whether or not the result is theoretically possible.

Further, in some embodiments, the data from the clamp meter is used to authenticate the mining component 104 and thus authenticate the machine (e.g., heat pump 102), such as by zero knowledge proof or the like.

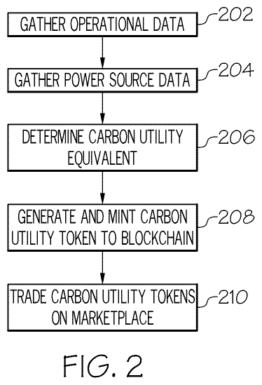

Referring now to FIG. 2, an example method for minting carbon utility tokens is illustrated. At block 202 operational data of the machine is gathered. As a non-limiting example, electrical current measured by a clamp meter is recorded. Other information may also be gathered, such as operating temperature. The operational data that is gathered is used to calculate a consumption metric, such as cOP or some other metric.

At block 204 source data relating to the electrical power provided by a power provider is gathered. This source data is reflective of the energy blend, or carbon intensity, of the power generators that produce the electrical energy provided by the power provider. A power blend value is calculated from the source data, where the higher the power blend value, the more carbon neutral and therefore “green” the electrical power consumed by the machine is. In some embodiments source data is not gathered and utilized.

At block 206 the carbon utility equivalent is calculated. The higher the carbon utility equivalent, the more efficient and clean the operation of the machine.

At block 208 carbon utility tokens are generated based on the carbon utility equivalents that are calculated. These carbon utility tokens can be recorded on a blockchain, where they may be traded on a marketplace at block 210. This ensures that the amount of carbon that is on the blockchain at any given time is tied to the carbon utility of the equipment operating on the blockchain, and may take advantage of any form of maintenance on the blockchain provided by the smart contracts or other means of maintaining the blockchain.

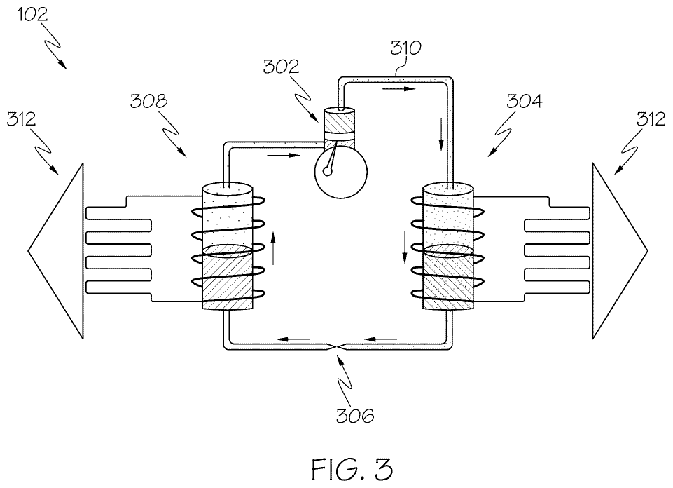

Referring now to FIG. 3, components of a non-limiting example heat pump 102 are schematically illustrated. The heat pump 102 includes a refrigerant 310 that is routed between two spaces to transfer heat therebetween. As stated above, in a cooling mode the refrigerant of the heat pump 102 absorbs heat from an interior space and moves it to an exterior space. In a heating mode the refrigerant 310 of the heat pump 102 absorbs heat from an exterior space and moves it to an interior space. The compressor 302 receives refrigerant 310 from the evaporator coil 308 and increases its pressure, substantially raising the temperature of the refrigerant 310, which is now in a gaseous phase. The gaseous refrigerant 310 is routed through the condenser coil 304. A fan 312 blows air over the condenser coil 304, which causes heat to be removed from the refrigerant 310. The refrigerant 310 is condensed from a gas into a liquid within the condenser coil 304. The refrigerant 310 then flows into an expansion valve 306, which rapidly decreases the temperature of the refrigerant 310 and therefore also rapidly chills the refrigerant 310. Then, the refrigerant 310 flows through the evaporator coil 308. A fan 312 blows air over the evaporator coil 308, which assists in the refrigerant 310 absorbing heat within the evaporator coil 308, which causes the refrigerant 310 to once again turn from a liquid to a gas. The gaseous refrigerant 310 then flows to the compressor 302 to continue the cycle.

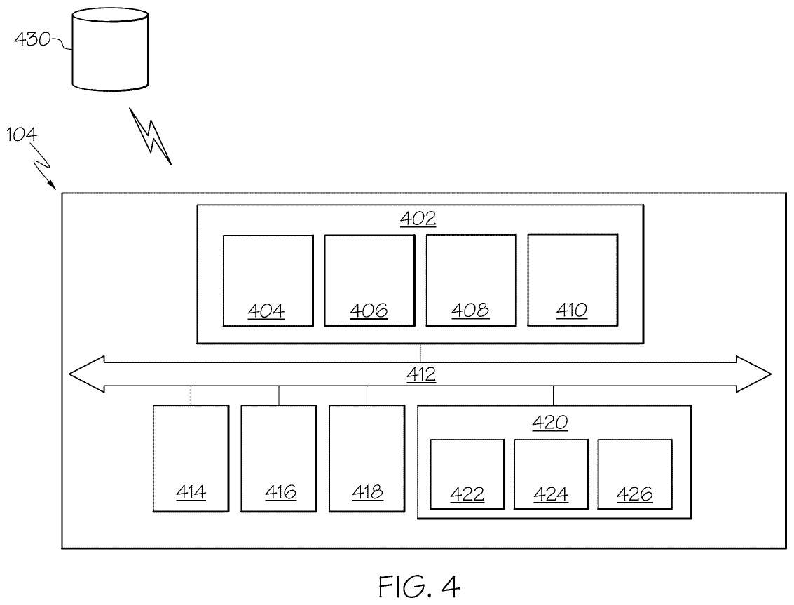

Referring now to FIG. 4, an example mining component 104 for generating carbon utility tokens and controlling a heat pump 102 is schematically illustrated. The example mining component 104 provides a system for generating and recording carbon utility tokens, and/or a non-transitory computer usable medium having computer readable program code for generating and recording carbon utility tokens embodied as hardware, software, and/or firmware, according to embodiments shown and described herein. While in some embodiments, the mining component 104 may be configured as a general purpose computer with the requisite hardware, software, and/or firmware, in some embodiments, mining component 104 may be configured as a special purpose computer, a programmable logic controller, or a system-on-a chip designed specifically for performing the functionality described herein. It should be understood that the software, hardware, and/or firmware components depicted in FIG. 4 may also be provided in other computing devices external to the mining component 104 (e.g., data storage devices, remote server computing devices, and the like).

As also illustrated in FIG. 4, the mining component 104 (or other additional computing devices) may include one or more processors 414, input/output hardware 416, network interface hardware 418, a data storage component 420 (which may include operational data 422 of a machine, source data 424 of the power sources used by the power provider, and any other data 426 for performing the functionalities described herein), and a non-transitory memory component 402. The non-transitory memory component 402 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components.

Additionally, the mining component 104 may be configured to store operating logic 404, carbon utility logic 406 for determining the carbon utility equivalents described herein, minting logic 408 for generating carbon utility tokens as described herein, and blockchain logic 410 for recording and transacting carbon utility tokens on one or more blockchains as described herein (each of which may be embodied as computer readable program code, firmware, or hardware, as an example). It should be understood that the data storage component 420 may reside local to and/or remote from the mining component 104, and may be configured to store one or more pieces of data for access by the mining component and/or other components.

A communication bus 412 is also included in FIG. 4 and may be implemented as a bus or other interface to facilitate communication among the components of the mining component 104.

The processor 414 may include any processing component configured to receive and execute computer readable code instructions (such as from the data storage component 420 and/or non-transitory memory component 402). The input/output hardware 416 may include one or more of graphics display device, keyboard, mouse, printer, camera, microphone, speaker, touch-screen, and/or other device for receiving, sending, and/or presenting data. The network interface hardware 418 may include any wired or wireless networking hardware, such as a modem, LAN port, wireless fidelity (Wi-Fi) card, WiMax card, mobile communications hardware, and/or other hardware for communicating with other networks and/or devices. The network interface hardware 418 may communicate via the Internet to receive data from one or more external data stores 430, such as power source data relating to power generation, consumption metrics for machines, and any other data that may be remotely stored and accessed.

Included in the non-transitory memory component 402 may be the operating logic 404, carbon utility logic 406, minting logic 408, and blockchain logic 410. The operating logic 404 may include an operating system and/or other software for managing components of the mining component 104. Similarly, the carbon utility logic 406 may reside in the non-transitory memory component 402 and may be configured to determine carbon utility equivalents of machines as described herein. The minting logic 408 also may reside in the non-transitory memory component 402 and may be configured to generate carbon utility tokens from the carbon utility equivalents for machines equipped with a mining component 104. The blockchain logic 410 is configured to record and transact carbon utility tokens on a blockchain.

The components illustrated in FIG. 4 are merely exemplary and are not intended to limit the scope of this disclosure.

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application covers the modifications and variations provided they come within the scope of the appended claims and their equivalents.

What is claimed is:

1. A system comprising:
a machine comprising one or more electrical components; and
a mining component electrically coupled to the machine, the mining component comprising:
one or more processors;
a non-transitory computer-readable medium storing instructions that, when executed by the one or more processors, causes the one or more processors to:
generate operational data of the machine;
receive power source data;
determine a carbon utility equivalent from the operational data and the power source data;
generate a carbon utility token from the carbon utility equivalent; and
record the carbon utility token on a blockchain.

2. The system of claim 1, wherein:
the operational data comprises a number of kilowatt-hours consumed by the machine; and
the carbon utility equivalent is based on the number of kilowatt-hours consumed by the machine.

3. The system of claim 1, wherein the machine comprises a heat pump and the operational data comprises a coefficient of performance such that the carbon utility equivalent is based in part on the coefficient of performance of the heat pump.

4. The system of claim 1, wherein the power source data comprises an efficiency and a power blend of a power source providing electrical power to the machine such that the carbon utility equivalent is based in part on the efficiency and power blend of the power source.

5. The system of claim 1, wherein the instructions further cause the one or more processors to:
receive one or more operational parameters based on one or more of the carbon utility equivalent and the carbon utility token; and
send one or more control signals to the machine to control an operation of the machine based on the one or more operational parameters.

6. The system of claim 5, wherein the one or more operational parameters comprises a threshold carbon utility token rate.

7. The system of claim 6, wherein the operation of the machine comprises reducing a power the machine consumes for a period of time when the carbon utility token is below the threshold carbon utility token rate.

8. A method for operating a machine, the method comprising:
receiving operational data of the machine;
receiving power source data;
determining a carbon utility equivalent from the operational data and the power source data;
generating a carbon utility token from the carbon utility metric;
recording the carbon utility token on a blockchain;
receiving one or more operational parameters based on one or more of the carbon utility equivalent and the carbon utility token; and
controlling an operation of the machine based on the one or more operational parameters.

9. The method of claim 8, wherein:
the operational data comprises a number of kilowatt-hours consumed by the machine; and
the carbon utility equivalent is based on the number of kilowatt-hours consumed by the machine.

10. The method of claim 8, wherein the one or more operational parameters comprises a threshold carbon utility token rate.

11. The method of claim 10, wherein the operation of the machine comprises turning the machine off for a period of time when the carbon utility token is below the threshold carbon utility token rate.

12. The method of claim 10, wherein the power source data is received from a power provider or a third party provider.

13. The method of claim 10, wherein the operational data comprises a consumption metric corresponding with an efficiency of the machine.

14. A heat pump comprising:
an evaporator coil;
a condenser coil;
a compressor fluidly coupled to the evaporator coil and the condenser coil;
an expansion valve fluidly coupled to the evaporator coil and the condenser coil;
one or more fans operable to generate airflow over one or more of the evaporator coil and the condenser coil; and
a mining component comprising:
one or more processors; and
a non-transitory computer-readable medium storing instructions that, when executed by the one or more processors, causes the one or more processors to:
generate operational data of the heat pump;
receive power source data;
determine a carbon utility equivalent from the operational data and the power source data;
generate a carbon utility token from the carbon utility equivalent; and
record the carbon utility token on a blockchain.

15. The heat pump of claim 14, wherein:
the operational data comprises a number of kilowatt-hours consumed by the heat pump; and
the carbon utility equivalent is based on the number of kilowatt-hours consumed by the heat pump.

16. The heat pump of claim 14, wherein the operational data comprises a coefficient of performance such that the carbon utility equivalent is based in part on the coefficient of performance of the heat pump.

17. The heat pump of claim 14, wherein the power source data comprises an efficiency of a power source such that the carbon utility equivalent is based in part on the efficiency of the power source.

18. The heat pump of claim 14, wherein the instructions further cause the one or more processors to:
receive one or more operational parameters based on one or more of the carbon utility equivalent and the carbon utility token; and
send one or more control signals to control an operation of the heat pump based on the one or more operational parameters.

19. The heat pump of claim 18, wherein the one or more operational parameters comprises a threshold carbon utility token rate.

20. The heat pump of claim 19. wherein the operation of the heat pump comprises turning the heat pump off for a period of time when the carbon utility token is below the threshold carbon utility token rate.
